(19) United States
(12) Patent Application Publication
(10) Pub. No.: US 2026/0272770 A1
(43) Pub. Date: Sep. 17, 2026

(54) MASSAGER

(71) Applicants: Dongguan Qunan Technology Co., Ltd., Dongguan (CN); Shenzhen Zhonghongtian Technology Co., Ltd., Shenzhen (CN)

(72) Inventor: Bowen Zhu, Shenzhen (CN)

(21) Appl. No.: 19/564,211

(22) Filed: Mar. 12, 2026

(30) Foreign Application Priority Data
Mar. 13, 2025 (CN) 202520444325.2

(51) Int. Cl. A61H 23/00; A61H 23/02

(52) U.S. Cl. CPC A61H 23/006; A61H 23/0254; A61H 2201/149

(57) ABSTRACT

A massager includes a housing, an extensible member disposed within the housing, a driving mechanism operatively connected to the extensible member, and at least two swinging members connected to the extensible member. The driving mechanism is disposed within the housing and is configured to drive the extensible member to reciprocate along a lengthwise direction thereof. The swinging members extend outwardly from the housing. When the extensible member reciprocates along the lengthwise direction, the extensible member drives the swinging members to swing reciprocally.

### CROSS-REFERENCE TO RELATED APPLICATIONS

The present disclosure claims the priority of the Chinese patent application No. 202520444325.2, filed on March 13, 2025, the contents of which are incorporated herein by reference in their entirety.

### TECHNICAL FIELD

The present disclosure relates to a technical field of massaging devices, and in particular to a massager.

### BACKGROUND ART

A massager is a device that can promote blood circulation in users, and proper use of a massager can bring physical and mental pleasure. Massagers generally have structures such as vibrating components and swinging components to provide massage to users. The massager may include driving mechanisms configured to drive the swinging components to swing repeatedly and rhythmically.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a massager for massaging human body is provided. The massager includes a housing, an extensible member disposed within the housing, a driving mechanism operatively connected to the extensible member, and at least two swinging members connected to the extensible member. The driving mechanism is disposed within the housing and is configured to drive the extensible member to reciprocate along a lengthwise direction thereof. The swinging members extend outwardly from the housing. When the extensible member reciprocates along the lengthwise direction, the extensible member drives the swinging members to swing reciprocally.

### BRIEF DESCRIPTION OF THE DRAWINGS

Illustrative embodiments of the present disclosure are described in detail below with reference to the attached drawing figures.

FIG. 1 is a schematic view of a massager according to one embodiment of the present disclosure.

FIG. 2 is a schematic view of the massager shown in FIG. 1 with a soft body and part of a housing omitted.

FIG. 3 is a schematic view of an extensible member, a driving mechanism, and swinging members according to one embodiment of the present disclosure.

FIG. 4 is a partially enlarged view of portion A in FIG. 3.

FIG. 5 is another schematic view of the massager according to one embodiment of the present disclosure.

FIG. 6 is a further schematic view of the massager according to one embodiment of the present disclosure.

FIG. 7 is still another schematic view of the massager according to one embodiment of the present disclosure.

FIG. 8 is yet another schematic view of the massager according to one embodiment of the present disclosure.

FIG. 9 is a schematic view of a connecting member and a rotating wheel according to one embodiment of the present disclosure.

FIG. 10 is a schematic view of the rotating wheel.

FIG. 11 is a schematic view of the rotating wheel and a guide seat.

FIG. 12 is a schematic view of a connecting seat and the extensible member.

### REFERENCE NUMERALS

1000-massager;

100-housing; 110-notch;

200-extensible member; 210-mounting post;

300-driving mechanism; 310-rotary driving member; 320-reversing transmission structure; 321-rotating wheel; 3211-sliding groove; 322-connecting member; 3221-sliding post; 323-guide seat; 3231-guide groove; 324-connecting seat; 3241-guide block; 3242-installation groove; 3243-through hole;

400-swinging member; 410-connecting portion; 411-elongated slot; 420-rotating portion; 430-swinging portion;

500-soft body;

600-vibration motor.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms "first" and "second" are used for descriptive purposes only and cannot be understood as indicating or implying relative importance or implying the number of indicated technical features. Thus, the features defined as "first" and "second" may explicitly or implicitly include one or more of the features. In the description of embodiments of the application, "a plurality of" means two or more, unless otherwise specifically defined.

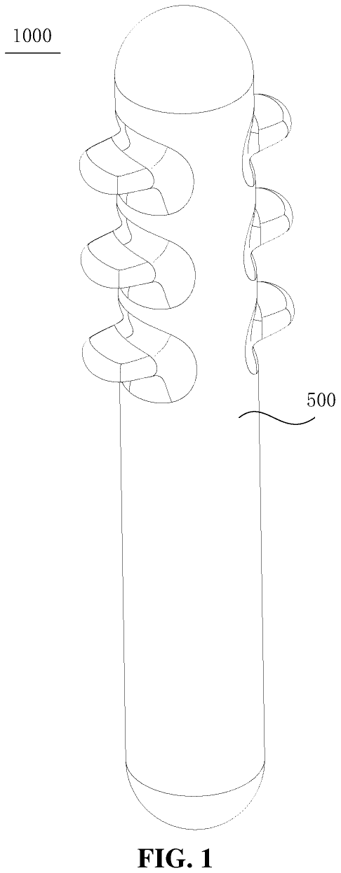

Embodiments of the present disclosure provide a massager 1000. As shown in FIGS. 1-4, the massager 1000 includes a housing 100, an extensible member 200, a driving mechanism 300, and at least two swinging members 400.

The extensible member 200 is disposed within the housing 100. At least two mounting posts 210 are provided on an outer peripheral surface of the extensible member 200. The at least two mounting posts 210 are spaced from each other and arranged along a length direction of the extensible member 200. The driving mechanism 300 is disposed within the housing 100 and connected to the extensible member 200 to drive the extensible member 200 to move linearly along the length direction.

A plurality of swinging members 400 respectively cooperate with the mounting posts 210 in a one-to-one manner. Each swinging member 400 includes a connecting portion 410, a rotating portion 420, and a swinging portion 430. The connecting portion 410 and the swinging portion 430 are respectively connected to two opposite sides of the rotating portion 420. The rotating portion 420 is rotatably connected to the housing 100. The connecting portion 410 defines an elongated slot 411. Each mounting post 210 extends through the elongated slot 411 of one corresponding swinging members 400. A length direction of the elongated slot 411 is substantially perpendicular to the length direction or axial direction of the extensible member 200.

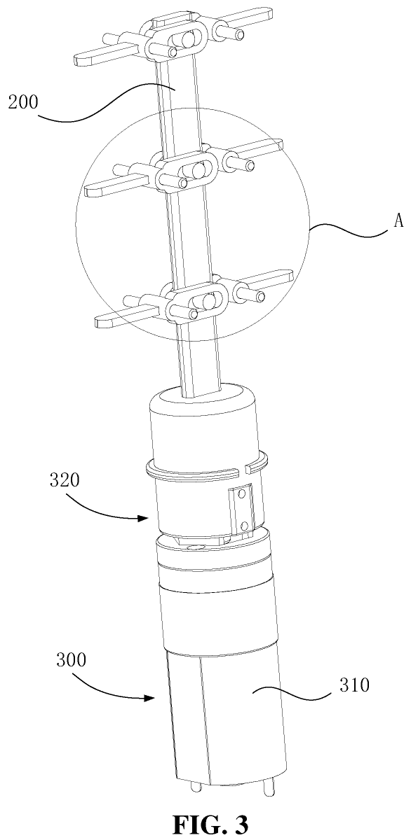

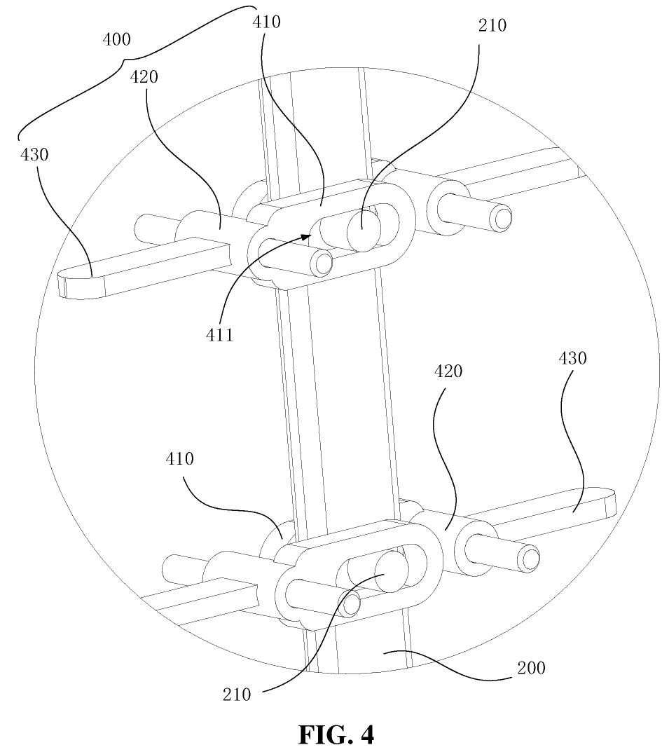

Referring to FIGS. 3 and 4, in one embodiment, the extensible member 200 may have an elongated sheet-like structure. The mounting posts 210 protrude outwards from opposite sides of the extensible member 200 and are evenly spaced along the extensible member 200. At a same height of the extensible member 200, there may be two mounting posts 210 protruding from opposite sides of the extensible member 200, and two swinging members 400 are connected to two mounting posts 210 at the same height. The two swinging members 400 at the same height is symmetrically about an axis of extensible member 200.

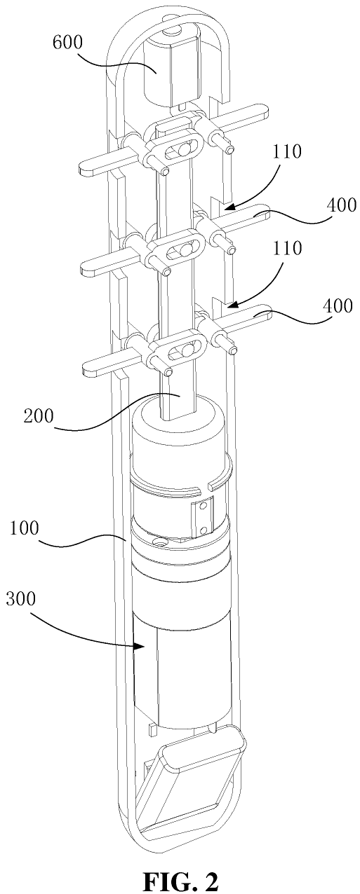

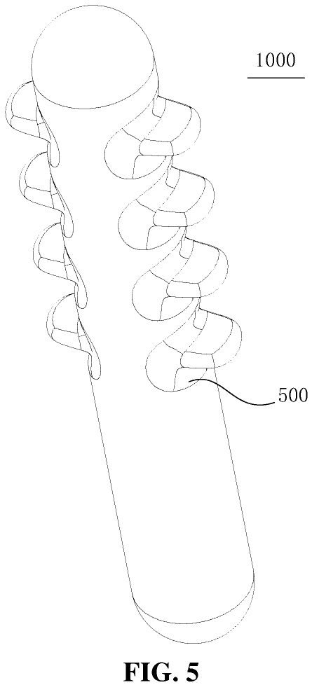

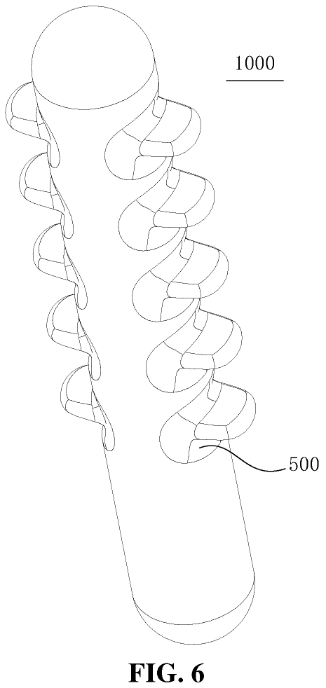

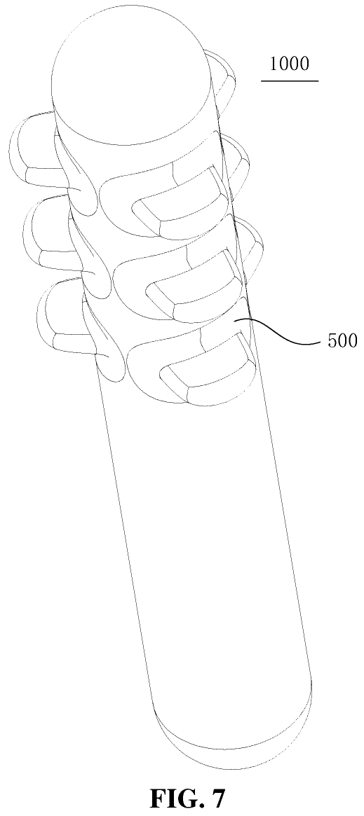

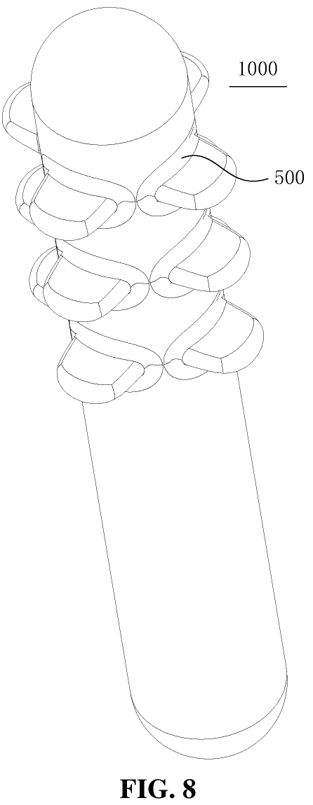

In different embodiments, the number of the swinging members 400 of the massager 1000 may be different. For example, FIGS. 1 and 2 shows three pair of swinging members 400 arranged symmetrically about the axis, FIG. 5 shows four pair of swinging members 400 arranged symmetrically about the axis, and FIG. 6 shows five pair of swinging members 400 arranged symmetrically about the axis. FIGS. 7 and 8 shows the swinging members 400 distributed around the outer periphery of the massager 1000, with a denser distribution at the same height.

Specifically, when the driving mechanism 300 drives the extensible member 200 to move linearly along the length direction, the mounting posts 210 on the extensible member 200 move correspondingly. Since the mounting posts 210 are inserted into the elongated slots 411 of the connecting portions 410, linear movement of the mounting posts 210 presses against inner walls of the elongated slots 411, thereby driving the connecting portions 410. Because the connecting portion 410 and the swinging portion 430 are located on opposite sides of the rotating portion 420, and the rotating portion 420 is rotatably connected to the housing 100, movement of the connecting portion 410 causes the swinging portion 430 to swing, thereby performing a massaging function for a user.

Referring to FIGS. 2-4, the mounting posts 210 may be arranged in different manners. In some embodiments, the fastening members 210 are spaced apart along the length direction of the extensible member 200. The number of fastening members 210 may be two, three, four, or more, which is not limited herein.

In some embodiments, at least two groups of mounting posts 210 may be provided, and multiple groups of mounting posts 210 may be circumferentially spaced around the extensible member 200. The number of mounting posts 210 may likewise be two, three, four, or more.

In some other embodiments, the mounting posts 210 may be circumferentially spaced along the extensible member 200.

Referring to FIG. 3, in some embodiments, the driving mechanism 300 includes a rotary driving member 310 and a reversing transmission structure 320. One end of the reversing transmission structure 320 is connected to the rotary driving member 310. The reversing transmission structure 320 is configured to convert rotational motion into linear motion. The extensible member 200 is connected to the other end of the reversing transmission structure 320.

It should be noted that a linear motor may also directly drive the extensible member 200 to perform linear motion. However, linear motors generally have larger sizes and higher costs, which would increase both the manufacturing cost and overall size of the massager 1000. In order to reduce production cost and minimize device size, the present embodiment adopts the rotary driving member 310 together with the reversing transmission structure 320 to convert rotational motion into linear motion.

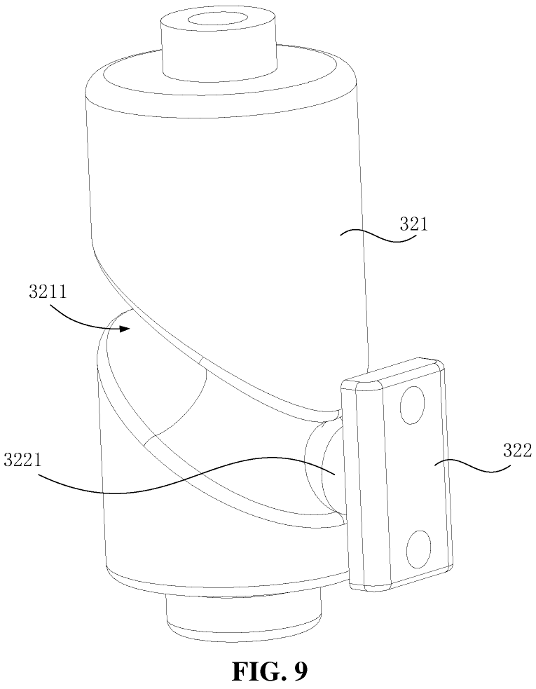

Referring to FIGS. 3 and 9, in some embodiments, the reversing transmission structure 320 includes a rotating wheel 321 and a connecting member 322. The rotating wheel 321 is connected to the rotary driving member 310. An outer peripheral surface of the rotating wheel 321 defines a sliding groove 3211. Specifically, the sliding groove 3211 is a closed spiral groove formed in an outer surface of the rotating wheel 321, and the sliding groove 3211 extends circumferentially around the cylinder by 360 degrees. The connecting member 322 is connected to the extensible member 200. A sliding post 3221 is protruded from the connecting member 322 and is slidably received in the sliding groove 3211.

When the rotary driving member 310 drives the rotating wheel 321 to rotate, the sliding groove 3211 rotates accordingly. Since the sliding post 3221 is received within the sliding groove 3211, groove walls of the sliding groove 3211 exert pressure on the sliding post 3221, thereby driving the sliding post 3221 to move along the length direction of the extensible member 200. Since the extensible member 200 is connected to the connecting member 322, the extensible member 200 moves linearly along its length direction correspondingly.

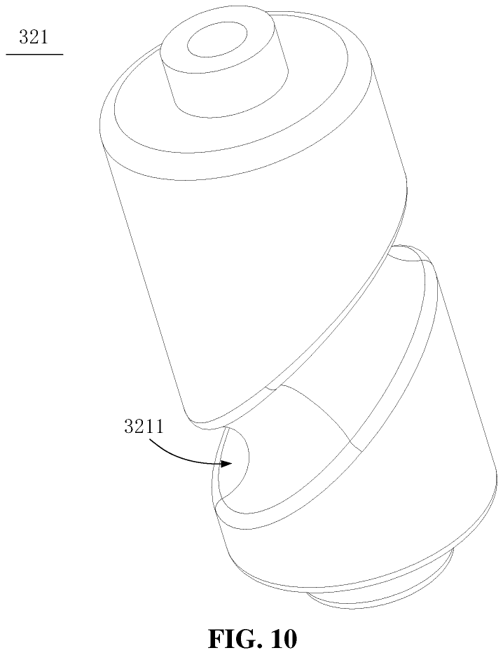

Referring to FIGS. 9 and 10, in some embodiments, the sliding groove 3211 surrounds the outer peripheral surface of the rotating wheel 321. The sliding groove 3211 is a closed spiral groove. Accordingly, even when the rotary driving member 310 continuously rotates in a single direction, reciprocating movement of the extensible member 200 can still be achieved, thereby simplifying the control manner.

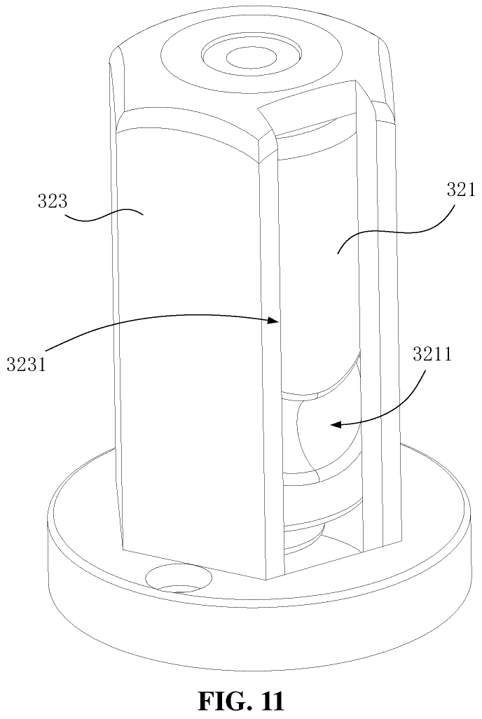

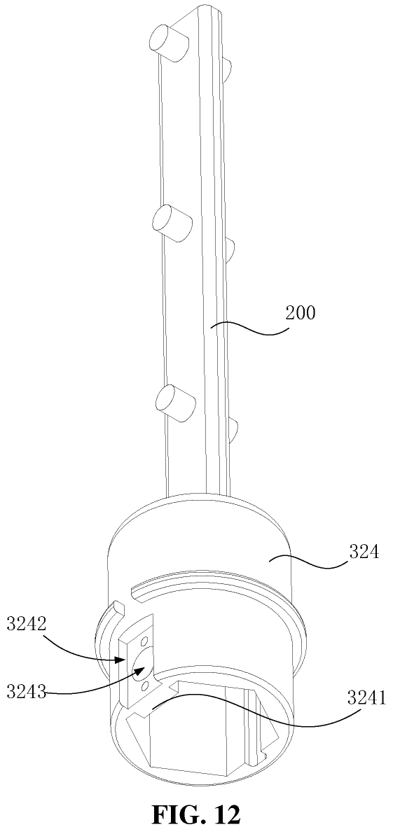

Referring to FIGS. 11 and 12, in some embodiments, the reversing transmission structure 320 further includes a guide seat 323 and a connecting seat 324. The guide seat 323 defines a guide groove 3231 extending along the length direction of the extensible member 200. The connecting seat 324 is disposed at one end of the extensible member 200 and is sleeved onto the guide seat 323. The connecting seat 324 is provided with a guide block 3241 inserted into the guide groove 3231, and the connecting member 322 is connected to the connecting seat 324.

Through cooperation between the guide groove 3231 and the guide block 3241, movement paths of the extensible member 200 and the connecting member 322 are guided and stabilized, thereby preventing unnecessary shaking. Moreover, since the connecting seat 324 is sleeved onto the guide seat 323, the size of the driving mechanism 300 can be reduced, facilitating miniaturization of the massager 1000.

Referring to FIG. 11, in some embodiments, the guide seat 323 covers the rotating wheel 321. The rotating wheel 321 is disposed within the guide seat 323, which may reduce the overall volume of the driving mechanism 300.

Referring to FIG. 12, in some embodiments, the connecting seat 324 and the extensible member 200 are integrally formed. Compared with separately formed components requiring assembly, integral formation prevents loosening during long-term use, reduces noise, and improves reliability, while also lowering mold and assembly costs.

Referring to FIGS. 3 and 12, in some embodiments, an outer side of the connecting seat 324 defines an installation groove 3242 opposite to the guide block 3241. A through hole 3243 is formed at a bottom of the installation groove 3242. The connecting member 322 is received within the installation groove 3242, and the sliding post 3221 passes through the through hole 3243 to engage with the sliding groove 3211.

The installation groove 3242 provides a defined mounting position for convenient assembly, reduces the size of the driving mechanism 300, and maintains sufficient structural strength due to its arrangement opposite the guide block 3241.

In some embodiments, the driving mechanism 300 further includes screws (not shown). The connecting member 322 is secured within the installation groove 3242 by screws, providing low-cost and stable fixation. Preferably, two screws are arranged on opposite sides of the sliding post 3221 to further enhance connection stability.

Referring to FIGS. 1 and 2, in some embodiments, the housing 100 defines a plurality of notches 110, and the swinging portion 430 of each swinging member 400 extends through a corresponding notch 110 so as to be exposed outside the housing 100. The massager 1000 further includes a soft body 500 covering the housing 100 and the exposed swinging portions 430.

The soft body 500 is made from soft rubber or silicone which provides improved tactile comfort compared with direct contact with the swinging members 400. Additionally, the soft body 500 seals the notches 110, preventing contaminants from entering the housing 100.

Referring to FIG. 2, in some embodiments, the massager 1000 further includes a vibration motor 600 disposed within the housing 100 and arranged adjacent to an upmost swinging member 400, enabling simultaneous swinging massage and vibration massage to enhance user experience.

In some embodiments, the driving mechanism 300 further includes a gear reduction set (not shown). The rotary driving member 310 is connected to the rotating wheel 321 via the gear reduction set, allowing adjustment of rotational speed so that massage performance meets user requirements.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A massager, comprising:
a housing;
an extensible member disposed within the housing;
a driving mechanism disposed within the housing and connected to the extensible member, the driving mechanism being configured to drive the extensible member to reciprocate along a length direction of the extensible member; and
at least two swinging members connected to the extensible member and extending out of the housing,
wherein when the extensible member is reciprocating along the length direction, the extensible member drives the swinging members to swing reciprocally.

2. The massager according to claim 1, wherein at least two mounting posts extends outwardly from the extensible member along a direction perpendicular to the length direction, each swinging member is connected to one of the at least two mounting posts.

3. The massager according to claim 2, wherein each swinging member comprises a connecting portion, a rotating portion, and a swinging portion, the connecting portion and the swinging portion are respectively connected to two opposite sides of the rotating portion, the rotating portion is rotatably connected to the housing, the connecting portion defines an elongated slot, and each mounting post is connected with the elongated slot of one of the at least two swinging members.

4. The massager according to claim 1, wherein the driving mechanism comprises a rotary driving member disposed within the housing; and a reversing transmission structure connected to the rotary driving member and configured to convert rotational motion into linear motion, wherein the reversing transmission structure is connected between the rotary driving member and the extensible member.

5. The massager according to claim 4, wherein the reversing transmission structure comprises:
a rotating wheel connected to the rotary driving member, an outer peripheral surface of the rotating wheel defining a sliding groove; an
a connecting member connected to the extensible member; the connecting member being provided with a sliding post inserted into the sliding groove.

6. The massager according to claim 5, wherein the sliding groove is a closed spiral groove formed in the outer peripheral surface of the rotating wheel, and the sliding groove extends circumferentially around the cylinder by 360 degrees.

7. The massager according to claim 5, wherein the reversing transmission structure further comprises:
a guide seat having a guide groove extending along the length direction; and
a connecting seat disposed at one end of the extensible member and sleeved onto the guide seat, the connecting seat having a guide block inserted into the guide groove, wherein the connecting member is connected to the connecting seat.

8. The massager according to claim 7, wherein an outer side of the connecting seat defines an installation groove opposite to the guide block, a through hole is formed at a bottom of the installation groove, the connecting member is mounted in the installation groove, and the sliding post passes through the through hole to engage with the sliding groove.

9. The massager according to claim 7, wherein the connecting seat and the extensible member are integrally formed.

10. The massager according to claim 3, wherein the housing is provided with a plurality of notches, and the swinging portion of each swinging member passes through one of the plurality of notches so as to be exposed outside the housing; the massager further comprising a soft body covering the housing and the swinging portion exposed outside the housing.

11. The massager according to claim 2, wherein the at least two mounting posts are spaced apart from each other along the length direction of the extensible member.

12. The massager according to claim 2, wherein the at least two mounting posts comprise a pair of mounting posts protruding from opposite sides of the extensible member at the same height, the at least two swinging members comprises a pair of swinging members connected to the pair of mounting posts, and the pair of swinging members are symmetrical about an axis of the extensible member.

13. The massager according to claim 1, further comprising a vibration motor disposed within the housing, wherein the vibration motor is arranged adjacent to one end of the extensible member, and another end of the extensible member is connected to the driving mechanism.

14. The massager according to claim 1, wherein the at least two swinging members are symmetrically arranged about an axial of the extensible member.
